(19) United States
(12) Patent Application Publication
(10) Pub. No.: US 2005/0050063 A1
(43) Pub. Date: Mar. 3, 2005

(54) Data management system and method with multi-port processor

(76) Inventors: William Robert Haas, Fort Collins, CO (US); Kirk Steven Tecu, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/649,907

(22) Filed: Aug. 26, 2003

(51) Int. Cl. G06F 17/00

(52) U.S. Cl. 707/100

(57) ABSTRACT

A data management system and method comprises a plurality of data ports coupled to a processor. The processor is programmed to test for the presence of a controller alternately through each of said plurality of data ports. In an embodiment, a data management method comprises testing for the presence of a controller through a first port using a processor, and testing for the presence of the controller through a second port if the controller is not found through the first port.

### BACKGROUND

Electronic devices which capture, create, store, manipulate or transfer digital music, sound, images, movies or other encoded data have become more prevalent with the advent of less expensive semiconductor processing and increased consumer demand. Applications such as portable MP3 (Moving Picture Experts Group layer 3 standard) players, PDAs (electronic personal data assistant), digital cameras and digital voice recorders continue to gain popularity. The general trend for each of these electronic applications is to provide increased capability and inter-operability with reduced form factor.

One standard that defines inter-operability between electronic devices includes the On-The-Go Rev 1.0 supplement (OTG) to the USB (universal serial bus) 2.0 standard. The OTG standard enables an MP3 player to connect to another MP3 player to transfer music files, a camera to connect to a printer to print a picture, or a PDA to connect to a cell phone to enable mobile web surfing. See Bethanee Martin, USB On-The-Go Spec Signals Developers To Proceed With a New Generation of Mobile Products Capable of Point-to-Point Data Exchange, ¶5 (Dec. 18, 2001). When one OTG-enabled device (the “A-device”) is attached to another (the “B-device”), a pull-up resistor within the B-device raises one line in their connection by a predetermined voltage amount. The A-device senses the voltage change and responds by sending an initialization signal. The B-device responds with bus bandwidth, access frequency, latency and error handling behavior requirements. The A-device assigns the B-device a unique identification number for data addressing. See Michael Gowan, How it Works: USB, PCWorld.com, ¶6 (Dec. 30, 1999). In subsequent communications, data is divided into 64-byte portions, each of which includes both addressing information and the data itself. Id. OTG cabling is asymmetric, with a Mini-A side and a Mini-B side. Devices have only one Mini-AB receptacle that accepts both Mini-A and Mini-B plugs. USB On-the-Go: A Tutorial, P.6, Koninklijke Philips Electronics (January 2002). The OTG-enabled host can have only one peripheral connected to it at a time, thus limiting its use.

One example of an electronic device which includes USB controller functionality is the STMP3300 audio decoder for use with MP3 players. Offered by Sigmatel, Inc., a USB port on the device enables MP3 and WMA (Windows™ media audio) file downloads. William Wong, 1-Chip MP3 Player Includes A USB Controller, Electronic Design, Jun. 4, 2001, V 49, I12, at 37. Unfortunately, the USB port requires a USB host PC (personal computer) to enable the USB connectivity.

An improved data management system and method is particularly important, since current standards do not allow serial connection of multiple B-devices with an A-device on either end and without the use of a PC.

### SUMMARY

A data management system and method has a plurality of data ports coupled to a processor. The processor is programmed to test for the presence of a controller alternately through each of the plurality of data ports.

In an embodiment, the method is described by testing for the presence of a controller through a first port using a processor and testing for the presence of said controller through a second port if said controller is not found through said first port.

### BRIEF DESCRIPTION OF THE DRAWINGS

The components in the figures are not necessarily to scale, emphasis instead being placed upon illustrating the principals of the invention. Moreover, in the figures, like reference numerals designate corresponding parts throughout the different views.

FIG. 1 is a flow diagram of one embodiment that illustrates the transmittal of a handshake through two ports to establish an application identification (“ID”) for a processor.

FIG. 2 is flow diagram of an embodiment that illustrates data flow from a controller module to an application module using the application ID established in FIG. 1.

FIG. 3 is a block diagram of an embodiment illustrating an application module used to establish the application ID and capture data having the application ID.

FIG. 4 is an exploded perspective view illustrating a portable electronic device with modular application modules to which the invention is applicable.

### DETAILED DESCRIPTION

One exemplary embodiment of the preferred embodiment comprises a portable modular system with detachably connectable controller, memory and application modules. In one version of the system, the controller module can be connected to a number of different application modules that are connected in series, with each application module including a pair of opposed data ports for connection to other modules. In one embodiment, the orientation of each application module is reversible, so that a given data port can be directed either towards or away from the controller module without affecting system operation. This system is the subject of application Ser. No. 10/307,034, filed Nov. 27, 2002, “Portable Modular Electronic System”.

The data management system described herein, in one embodiment, coordinates data flow between the various applications and the controller. A data addressing protocol is established to enable routing of packet data through the system. The protocol can be appended to the packet data in an addressing portion. The protocol can also precede the packet data to enable routing between the applications and controller. The system includes a plurality of data ports coupled to a processor. The processor is programmed to test for the presence of a controller alternately through each of the plurality of data ports to receive an application ID from the controller. Further, the system enables other application modules to be connected serially with the controller module and the processor in the first application module.

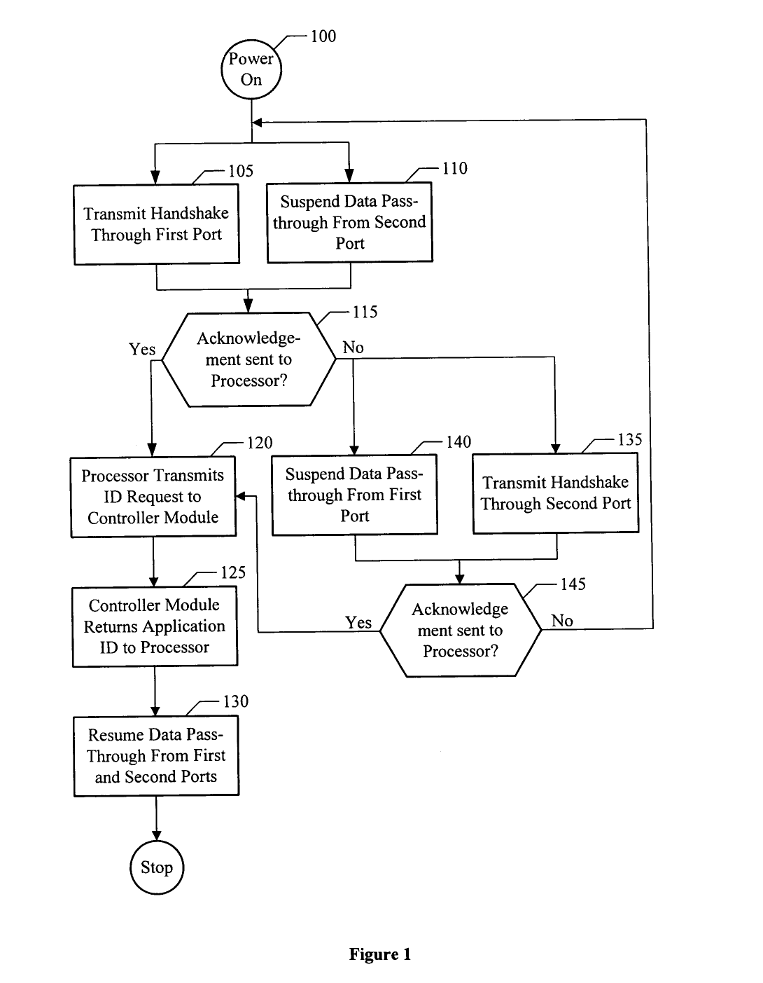

FIG. 1 is a flow diagram, for one embodiment of the invention, which illustrates how a processor in an application module receives an application ID from a controller module. In a packet-data system, the application ID is contained in an addressing portion of a data packet and represents the electronic address of the processor in the system. Receipt of the application ID enables for the processor to later request and retrieve data. The application module includes at least two data ports, either of which can be connected to a controller module, depending upon the relative orientations of the modules. The application module is turned on (block 100) and a controller handshake is transmitted by the processor through a first data port (block 105) of a hub to determine whether a controller module is connected to that port. Incoming data from a second data port in the hub is inhibited to avoid interference with the controller handshake transmission (block 110). The protocol for the handshake transmission includes information that enables the controller module to respond to the controller handshake with an acknowledgement if the controller module is connected to the first port. For example, the controller handshake could include a request to inhibit data transmission from the controller module and send an acknowledgement that the controller handshake was received. Or, the controller handshake could include other identifying information such as protocol version number, application module type, or an authentication certificate that enables the controller module to respond with an acknowledgement.

If an acknowledgement is sent to the processor (block 115) within a pre-determined time period, the processor transmits an application ID request to the controller module (block 120). The controller module responds by transmitting an application ID to the processor (block 125). The application ID is stored in internal memory for later retrieval and use. The controller module also has an ID, and its ID is transmitted to the application module either with the acknowledgement, with the application ID, or subsequently to allow routing of subsequent data requests without having to repeat the controller-handshake process. Data pass-through is then resumed from the first and second ports (block 130) and the handshaking process is complete. The controller appends the application ID onto subsequent data transmitted to the application module to enable proper data routing.

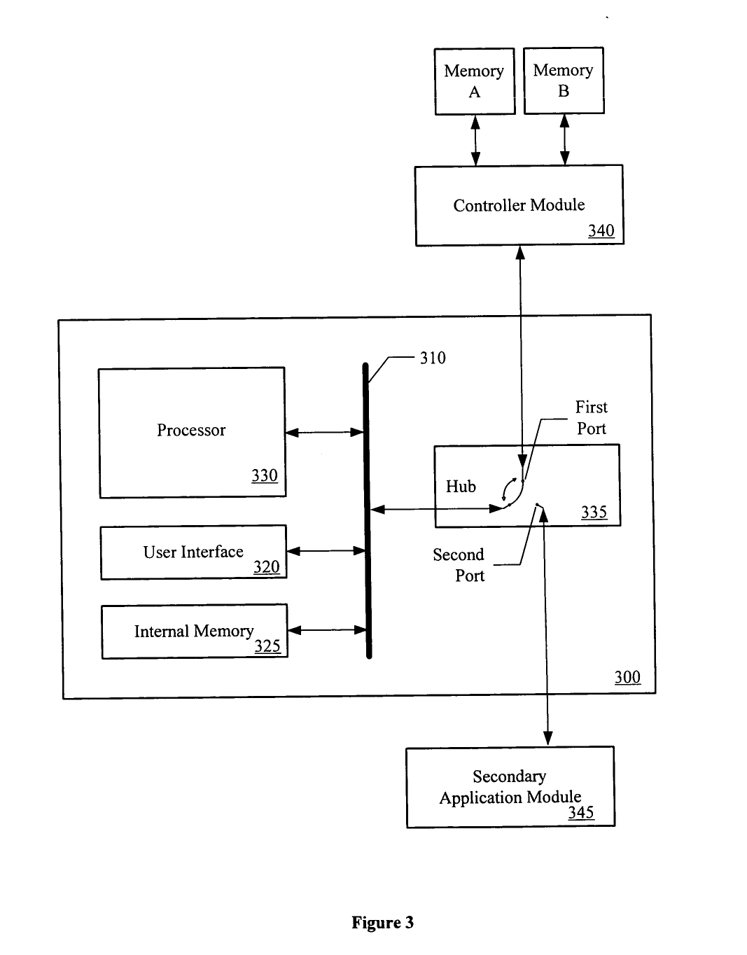

If the original controller handshake transmittal through the first data port does not result in an acknowledgement (blocks 105, 115), indicating that no controller module is connected to the first port, the application module looks for the presence of a controller module at its second data port by transmitting a controller handshake through the second port (block 235). Data pass-through is inhibited through the first data port (block 140) to prevent interference. If an acknowledgement is returned (block 145), indicating the presence of a controller module at the second port, the processor transmits an ID, request to retrieve a processor ID and resumes data pass-through from both ports (blocks 120, 125, 130). Although the description of FIG. 3 includes only two data ports, its process may be extended to more than two data ports. If more than two data ports are provided, each data port would be tested in turn to determine whether a controller module is connected to that data port. The processor would inhibit data pass-through through each data port not being tested.

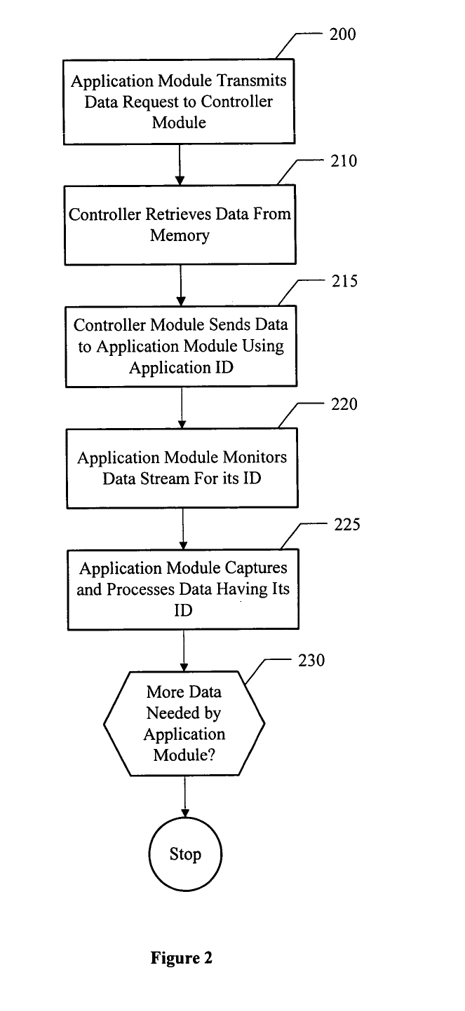

FIG. 2 is a flow diagram that shows a possible scheme for data retrieval and capture by the application module using the processor ID acquired in FIG. 2. The processor in the application module transmits a data request to the controller module (block 200) through the hub. The controller module sends a request for the data to memory (block 210) and transmits the retrieved data with the processor ID to the application module (block 215). The application module monitors the incoming data for data having its processor ID (block 220) to route the incoming data to the processor. The retrieved data is captured and provided to the processor for processing (block 225). If more data is needed by the processor, a new data request is transmitted using the targeted device's ID for routing (block 230).

FIG. 3 illustrates an implementation of an application module 300. It includes a data bus 310 in communication with a user interface 320, an internal memory 325, a processor with an embedded controller 330, and a hub 335. The hub 335 can communicate with the controller module 340 and a second application module 345 through first and second ports in the hub, respectively. The controller module 340 is connected to redundant memories A and B for data storage and access.

The processor 330 implements an application such as an MP3 player, PDA, digital camera or digital voice recorder. The processor 330 accepts user input and provides status information to the user through a user interface 320. The processor 330 is programmed to transmit a controller handshake signal through one data port and to inhibit data pass-through at the second port, and to then transmit a controller-handshake signal through the second data port and inhibit data pass-through at the first data port in case no controller module is located at the first port, to establish the initial communication with the controller module 340. Switching in the hub for the initial communication is controlled by the processor. The controller module 340 is programmed to return an application module ID to the processor 330 in response to receiving the controller-handshake signal. As described above, the application module's internal memory 325 stores the application module ID for use by the hub and processor. The internal memory 325 also enables efficient buffering of data retrieved from memory A and B for use by the processor 330.

The hub 335 can be either a switching hub or a router having at least one switch that forwards the data to the appropriate data port or to the processor 330, based on the ID contained in the addressing portion of the data packet (see FIG. 1). For example, if data entering through the first data port does not match the application ID, the processor is programmed to cause the hub to switch so that the data continues through the second port. If the data came from the data port in communication with the controller module 340, the data would be communicated to the second application module at the opposite data port (if attached). Data retrieved from memories A or B for the processor 330 would be addressed with the application ID and switched by the hub 335 to the processor 330.

The internal memory 325 may be integrated onto a single chip with the processor 330. The data bus 310 is illustrated with electrically conductive paths between the processor 330, user interface 320, and internal memory 325. Other signal transport mechanisms, such as an optical bus, may also be used. A wireless scheme utilizing Bluetooth™ or other wireless technology could also be provided for the data path between the controller module 340, memories A and B and the application module 300.

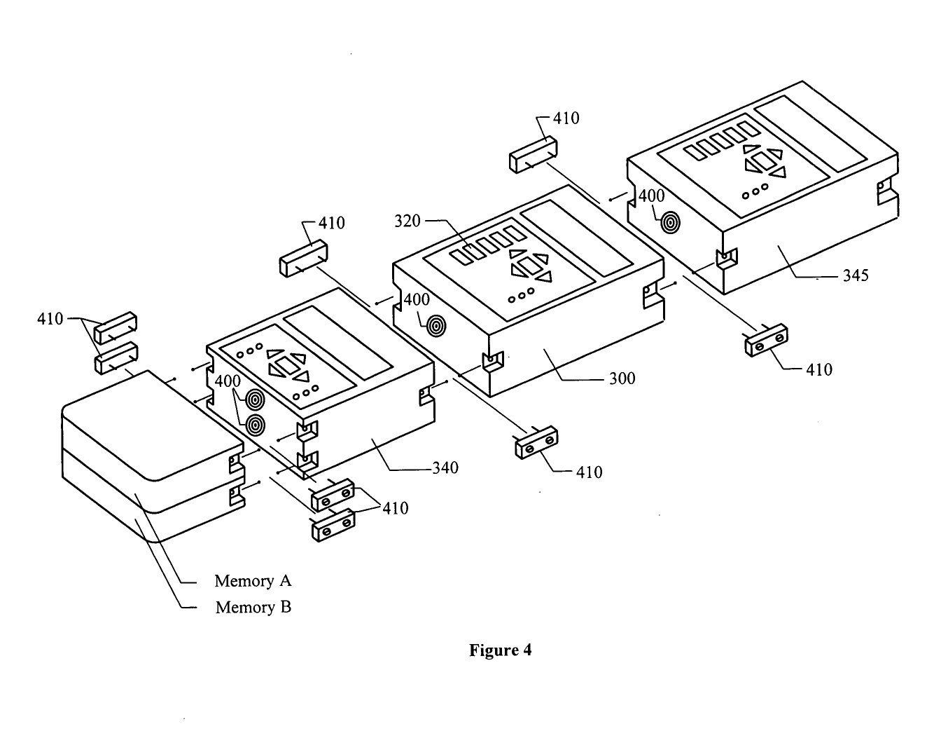

The invention has numerous embodiments, such as a portable handheld modular consumer electronic product such as that shown in FIG. 4. Such a modular system allows a controller module, such as that illustrated in FIG. 3, and multiple memories to be packaged together by the consumer with whichever application modules the consumer desires. In FIG. 4, the controller module 340 is shown aligned for electrical and mechanical connection with the application module 300 through an electrical connector 400 in the application module and a complementary, opposed connector (not shown) in the controller module 340, and mechanical connectors 410. The controller module 340 manages files sent from the application module 300 to memories A and B. As shown in FIG. 3, the application module 300 can be connected in turn to a second application module 345 through additional electrical and mechanical connectors (400, 410). In such a case, the controller module 340 may distinguish between data from the different application modules by the data-addressing scheme described in connection with FIGS. 1 through 3.

Memories A and B are shown aligned for electrical connection with the controller module through a pair of electrical connectors 400 in the controller module, and a complementary pair of electrical connectors (not shown) in the memories, one for each memory. Each memory can be individually replaced if it goes bad, and a new memory installed with either the same or an 180°-rotated orientation with respect to the controller module 340.

While various embodiments of the invention have been described, it will be apparent to those of ordinary skill in the art that many more embodiments and implementations are possible within the scope of this invention. For example, the application module could have more than two ports for connection to other modules, in which case the processor could be programmed to transmit a controller handshake through each data port in succession until a controller is located. Accordingly, it is intended that the invention be limited only in terms of the appended claims.

1. A data management system, comprising:
a processor; and
first and second ports;
wherein the processor is programmed to transmit a first controller handshake signal through said first data port, and inhibit data pass-through at said second data port in connection with said first controller handshake signal transmission.

2. The system of claim 1, wherein said processor is programmed to transmit a second controller handshake signal through said second data port to establish communication with a controller if said first handshake signal does not result in communication with a controller, and inhibit data pass-through at said first data port in connection with said second controller handshake signal transmission.

3. The system of claim 2, further comprising:
a data hub that includes said first and second ports.

4. The system of claim 3, wherein said data hub comprises at least one switch connectable to alternately inhibit data pass-through at said first and second ports.

5. The system of claim 2, wherein said processor and said first and second ports are housed in an application module.

6. The system of claim 1, further comprising:
a controller module in communication with said processor through said first port.

7. The system of claim 6, further comprising:
an application module in communication with said processor through said second port.

8. The system of claim 7, further comprising:
a plurality of memories detachably connected to said controller module.

9. The system of claim 6, wherein said processor is programmed to transmit an ID request to said controller module.

10. The system of claim 9, wherein said controller module is programmed to transmit an application ID to said processor in response to said ID request.

11. The system of claim 10, wherein said controller module is programmed to append said application ID onto other data transmitted to said processor.

12. A method for coordinating data flow, comprising:
transmitting a first handshake signal from a processor through a first data port to test for the presence of a controller at said first port; and
inhibiting data pass-through at a second data port in connection with said first handshake signal transmission.

13. The method of claim 12, further comprising:
transmitting a second handshake signal through said second data port to test for the presence of a controller at said second data port if said first handshake signal does not result in communication with a controller at said first port; and
inhibiting data pass-through at said first data port in connection with the transmission of said second handshake signal.

14. The method of claim 13, wherein said inhibiting of data pass-through at said first and second ports further comprises switching at least one switch in a hub that comprises said first and second ports.

15. The method of claim 13, further comprising:
transmitting an ID request from said processor to a controller found to be present at one of said ports.

16. The method of claim 15, further comprising:
transmitting an application ID to said processor from said controller in response to said ID request.

17. The method of claim 16, further comprising:
appending said application ID onto data retrieved by said controller module from a memory.

18. A data management system, comprising:
a plurality of data ports coupled to a processor;
an application module housing said processor;
wherein said processor is programmed to test for the presence of a controller alternately through each of said plurality of data ports.

19. The data management system of claim 18, further comprising:
a data hub that comprises said plurality of data ports.

20. The data management system of claim 18, further comprising:
a controller in communication with said processor through one of said plurality of data ports.

21. The data management system of claim 20, wherein said controller is further programmed to send an application ID to said processor in response to receiving a transmission from said processor.

22. A system configuration method, comprising:
testing for the presence of a controller through a first port using a processor; and
testing for the presence of said controller through a second port if said controller is not found through said first port.

23. The method of claim 23, further comprising:
sending an ID request to said controller.

24. The method of claim 23, further comprising:
sending an application ID to said processor from said controller;
wherein said application ID represents an electronic address for said processor.

25. The method of claim 22, further comprising:
inhibiting data pass-through at said second port while testing through said first port.

26. The method of claim 22,
sending an acknowledgement from said controller to said processor.
